(19) United States
(12) Patent Application Publication
(10) Pub. No.: US 2025/0233848 A1
(43) Pub. Date: Jul. 17, 2025

(54) METHOD, DEVICE, AND PROGRAM PRODUCT FOR PROTECTING INTERNET-OF-THINGS DEVICE

(71) Applicant: Dell Products L.P., Round Rock, TX (US)

(72) Inventors: Chenxi Hu, Beijing (CN); Sanping Li, Beijing (CN); Zhen Jia, Shanghai (CN); Anzhou Hou, Shanghai (CN)

(21) Appl. No.: 18/433,695

(22) Filed: Feb. 6, 2024

(30) Foreign Application Priority Data
Jan. 12, 2024 (CN) 202410048611.7

(51) Int. Cl. H04L 9/40

(52) U.S. Cl. CPC H04L 63/0236; H04L 63/101; H04L 63/20

(57) ABSTRACT

Embodiments of the present disclosure relate to a method, an apparatus, a device, and a medium for protecting an internet-of-things device. The method includes receiving a data packet associated with the internet-of-things device. The method further includes determining whether the data packet is for a to-be-protected target internet-of-things device based on a service identification in the data packet. The method further includes filtering, in response to the data packet being for the to-be-protected target internet-of-things device, the data packet based on service forwarding information related to a service of the target internet-of-things device to protect the target internet-of-things device. Through the method, normal packets are forwarded and possible attack data packets are abandoned by filtering the data packets, and thus the internet-of-things device is prevented from being attacked, which improves the security of the internet-of-things device and improves the user experience.

### RELATED APPLICATION

The present application claims priority to Chinese Patent Application No. 202410048611.7, filed Jan. 12, 2024, and entitled “Method, Device, and Program Product for Protecting Internet-of-Things Device,” which is incorporated by reference herein in its entirety.

### FIELD

Embodiments of the present disclosure generally relate to the field of the internet-of-things, and in particular, to a method, a device, and a program product for protecting an internet-of-things device.

### BACKGROUND

The internet-of-things is a vast network that includes various devices and articles connected to each other through the internet. Due to the network connectivity of various devices and articles, the devices in the internet-of-things can exchange and communicate information. With the ongoing development of the internet-of-things, increasingly advanced services can be provided in application fields such as e-government, agriculture, transportation, education, smart home, healthcare, and electronic shopping.

Various network devices are also widely used in the internet-of-things, such as various servers and security gateways. Due to the application of the network devices in the internet-of-things, a given device in the internet-of-things can interact and communicate with other devices in the internet-of-things. However, there are still many issues that need to be addressed in terms of network security for internet-of-things devices.

### SUMMARY

Embodiments of the present disclosure provide a method, a device, and a program product for protecting an internet-of-things device.

According to a first aspect of the present disclosure, a method for protecting an internet-of-things device is provided. The method includes receiving a data packet associated with the internet-of-things device. The method further includes determining whether the data packet is for a to-be-protected target internet-of-things device based on a service identification in the data packet. The method further includes filtering, in response to the data packet being for the to-be-protected target internet-of-things device, the data packet based on service forwarding information related to a service of the target internet-of-things device to protect the target internet-of-things device.

According to a second aspect of the present disclosure, an electronic device is provided. The electronic device includes at least one processor; and a memory, coupled to the at least one processor and having instructions stored therein, wherein the instructions, when executed by the at least one processor, cause the electronic device to perform actions including: receiving a data packet associated with the internet-of-things device; determining whether the data packet is for a to-be-protected target internet-of-things device based on a service identification in the data packet; and filtering, in response to the data packet being for the to-be-protected target internet-of-things device, the data packet based on service forwarding information related to a service of the target internet-of-things device to protect the target internet-of-things device.

According to a third aspect of the present disclosure, a computer program product is provided. The computer program product is tangibly stored on a non-transitory computer-readable medium and includes machine-executable instructions, wherein the machine-executable instructions, when executed by a machine, cause the machine to perform steps of the method in the first aspect of the present disclosure.

### BRIEF DESCRIPTION OF THE DRAWINGS

By additional description of exemplary embodiments of the present disclosure, provided in more detail herein with reference to the accompanying drawings, the above and other objectives, features, and advantages of the present disclosure will become more apparent, wherein identical reference numerals generally represent identical components in the exemplary embodiments of the present disclosure, and in which:

FIG. 1 illustrates a schematic diagram of an example environment in which a device and/or a method according to an embodiment of the present disclosure can be implemented;

FIG. 2 illustrates a schematic diagram of an example of enhancing network security of an internet-of-things device according to an embodiment of the present disclosure;

FIG. 3 illustrates a flow chart of a method for protecting an internet-of-things device according to an embodiment of the present disclosure;

FIG. 4 illustrates a schematic diagram of an example of a flow of executing filtering on a data plane according to an embodiment of the present disclosure;

FIG. 5 illustrates a schematic diagram of an example of a header according to an embodiment of the present disclosure;

FIG. 6 illustrates a flow chart of an example used for enhancing network security of an internet-of-things device according to an embodiment of the present disclosure; and

FIG. 7 illustrates a block diagram of an example device suitable for implementing an embodiment of the present disclosure.

In various accompanying drawings, identical or corresponding reference numerals represent identical or corresponding parts.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

As described above, there are still many issues that need to be addressed in terms of network security for internet-of-things devices. For example, due to the widespread use of the internet-of-things devices by users, when the users are not aware that the internet-of-things devices are accessing their networks and if the internet-of-things devices are cracked and injected with malicious firmware, the internet-of-things devices in the users' networks are vulnerable to attacks and damage. Due to the insufficient attention paid by most internet-of-things device manufacturers to the security of the internet-of-things devices, the number of attack areas has increased. Attackers can exploit device vulnerabilities and launch network-based attacks (such as DDoS attacks, Mirai, and VPNFilter), which have serious negative impacts on critical infrastructure.

Due to the characteristics of low cost, limited hardware use functionality, and limited applications of the internet-of-things devices, it is unrealistic to address security vulnerabilities of the internet-of-things devices by requiring all the internet-of-things devices to be equipped with robust and advanced security mechanisms. In addition, the internet-of-things devices are usually not open systems, but specifically designed for specific purposes. Therefore, finding improvement methods for network security for such internet-of-things devices without the need for costly or complex improvements to the devices per se is very challenging. In addition, some internet-of-things devices are vulnerable to attacks and inevitably suffer damage, and traditional solutions do not have sufficient security mechanisms to protect all the internet-of-things devices from damage.

In order to at least address the above and other potential problems, an embodiment of the present disclosure provides a method for protecting an internet-of-things device. In the method, a computing device receives a data packet associated with the internet-of-things device. After receiving the data packet, the computing device further determines whether the data packet is for a to-be-protected target internet-of-things device by using a service identification in the data packet. If the data packet is for the to-be-protected target internet-of-things device, the computing device filters the data packet by using local service forwarding information. Through the method, normal packets are forwarded and possible attack data packets are abandoned by filtering the data packets, and thus the internet-of-things device is prevented from being attacked, which improves the security of the internet-of-things device and improves the user experience.

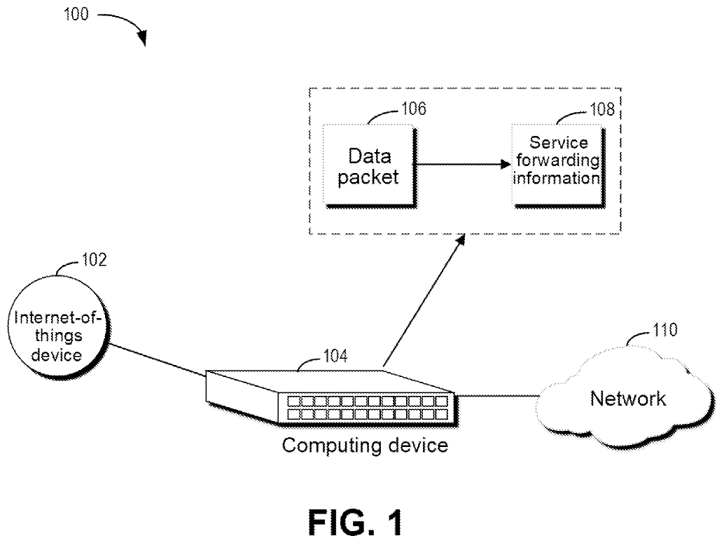

Embodiments of the present disclosure will be further described in detail below with reference to the accompanying drawings, wherein FIG. 1 shows an example environment in which a device and/or a method according to an embodiment of the present disclosure can be implemented.

As shown in FIG. 1, an example environment 100 includes an internet-of-things device 102. The internet-of-things device 102 may be various types of devices, such as a traffic light, a smart lock, a web camera, and an air conditioner controller. Different internet-of-things devices may process different data packets corresponding thereto. Additionally, a data packet may be service data sent by the internet-of-things device or service data received by the internet-of-things device, and such service data in some embodiments is referred to as being part of or otherwise associated with a “service” of the internet-of-things device.

The data packet or service of the internet-of-things device may be forwarded and managed by a computing device 104. For example, the computing device 104 in some embodiments is a programmable switch. In some embodiments, the programmable switch may be a P4 programmable switch. For the internet-of-things device 102, a corresponding data packet will be generated to be sent to the computing device 104. One internet-of-things device 102 connected with the computing device 104 is shown in FIG. 1, which is only an example, rather than a specific limitation to the present disclosure. In some embodiments, the computing device may be connected to any suitable number of internet-of-things devices. Alternatively or additionally, the internet-of-things device is connected to the computing device through a network device, for example, through customer premise equipment (CPE).

In FIG. 1, the internet-of-things device 102 and a network 110 are connected with the computing device 104 to interact with the computing device 104. The computing device 104 monitors the data packet 106 or service from the internet-of-things device 102 or from a device in the network 110. Additionally, the computing device 104 receives the data packet 106 from the internet-of-things device 102 via a network device such as the CPE, or forwards the data packet towards the internet-of-things device 102 via the network device.

In addition, the computing device 104 may obtain a service identification table associated with the to-be-protected internet-of-things device, and the service identification table at least includes an identification of the to-be-protected internet-of-things device and a corresponding service identification. For example, the service identification table in some embodiments is a differentiated services code point (DSCP) table, which includes DSCPs allocated to the to-be-protected internet-of-things device as service identifications. Then, the computing device 104 determines whether a service identification matching with the service identifications in the service identification table exists in the data packet. If there is no service identification matching with the service identification table, it indicates that the data packet is not for the to-be-protected internet-of-things device, for example, the data packet is not from or to the to-be-protected internet-of-things device, and then the data packet may be normally processed, for example, the data packet is directly forwarded.

If the service identifications in the service identification table exist, it indicates that the data packet is for a to-be-protected target internet-of-things device, and then service forwarding information 108 stored at the computing device needs to be further obtained to perform a further filtering operation on the data packet. For example, an ahead forwarding table and a back forwarding table at the computing device are utilized to filter data packets from the internet-of-things device and from a server in the network 110 respectively.

Through the method, normal packets are forwarded and possible attack data packets are abandoned by filtering the data packets, and thus the internet-of-things device is prevented from being attacked, which improves the security of the internet-of-things device and improves the user experience.

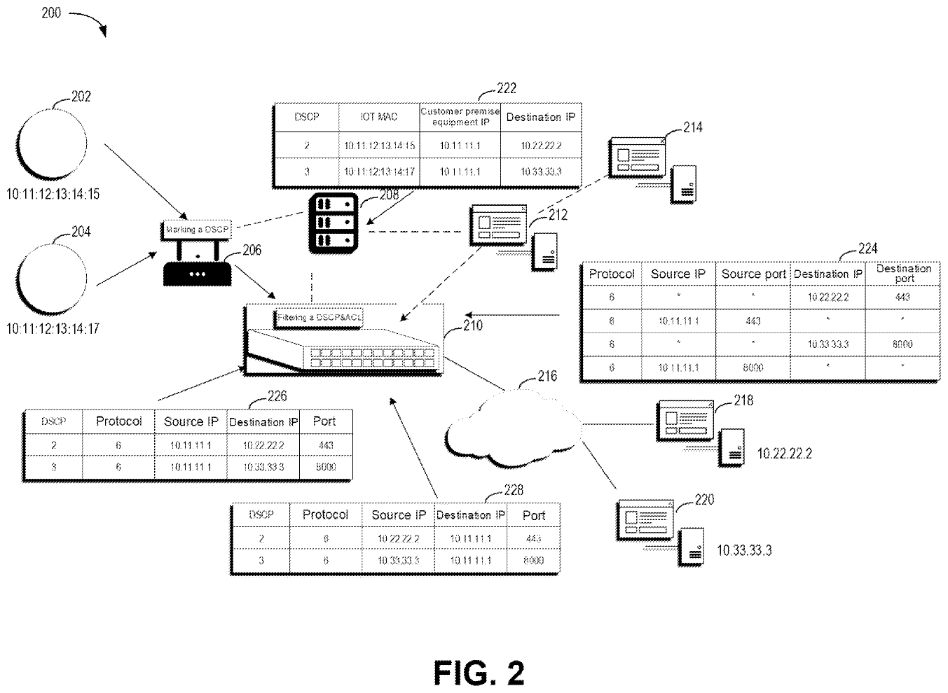

The example environment in which the device and/or a method according to an embodiment of the present disclosure can be implemented has been described above in conjunction with FIG. 1. A schematic diagram of an example used for enhancing network security of the internet-of-things device according to an embodiment of the present disclosure is described below in conjunction with FIG. 2.

As shown in FIG. 2, a specific example 200 of the network environment in FIG. 1 is illustrated in more detail. In this example, data packets or services sent or received by an internet-of-things device 202 and an internet-of-things device 204 may be filtered. For the internet-of-things device 202 and the internet-of-things device 204, corresponding data packets or services will be generated, and data packets from a server in a network may also be received.

Customer premise equipment 206 in FIG. 2 communicates with the internet-of-things device 202 and the internet-of-things device 204, and is configured to receive the data packets from the internet-of-things device 202 and the internet-of-things device 204 or forward the data packets to the internet-of-things device 202 and the internet-of-things device 204. The customer premise equipment 206 may obtain a DSCP table 222 through an automatic configuration server 208. The DSCP table 222 stores media access control (MAC) addresses of the internet-of-things device 202 to be protected and the internet-of-things device 204 to be protected as well as service identifications allocated for their services, such as DSCPs. The DSCP table further stores Internet protocol (IP) addresses of customer premise equipment using the table and IP addresses of destinations to which data of a target internet-of-things device are to be sent. As shown in FIG. 2, a DSCP allocated to the internet-of-things device 202 is 2, and a DSCP allocated to the internet-of-things device 204 is 3.

Then, the customer premise equipment 206 is configured to determine which internet-of-things device a data packet is from according to a media access control (MAC) address in the data packet received from the internet-of-things device, and to find a DSCP mark corresponding to the MAC address in the data packet from the DSCP table 222 so as to label the data packet. For example, if the data packet received by the customer premise equipment 206 has a MAC address 10:11:12:13:14:15 corresponding to the internet-of-things device 202, it can be found from the DSCP table that the DSCP corresponding to the internet-of-things device is 2, then the data packet is labeled that the DSCP is 2, and at this time, a DSCP field of a header of the packaged data packet is marked as 2. Additionally, if the MAC address of the received data packet does not exist in the DSCP table, then the data packet may not be labeled or may be marked with a default label. Additionally, the customer premise equipment 206 further updates the DSCP table through the automatic configuration server 208.

As shown in FIG. 2, the DSCP table 222 obtained by the customer premise equipment 206 is obtained from a software-defined network (SDN) controller 212 via the automatic configuration server 208. The software-defined network controller 212 generates the table according to a usage description for the to-be-protected internet-of-things device obtained from a manufacturer usage description (MUD) server 214.

The manufacturer usage description server 214 stores usage descriptions containing configuration information and access strategies of the internet-of-things devices and/or other network devices. In some embodiments, the usage description in the manufacturer usage description server 214 is a segment of JavaScript object notation (JSON) data. In some embodiments, the software-defined network controller 212 generates the corresponding configuration information based on the usage descriptions in the manufacturer usage description server 214, the usage descriptions may be predefined when the internet-of-things devices leave factories, and thus the generated configuration information is predefined. In this case, users are not required to participate in the generation of the configuration information. In some embodiments, since the usage descriptions in the manufacturer usage description server 214 may be modified and updated, the software-defined network controller 212 at this time will update corresponding configurations according to the modified usage descriptions, and in this case, the usage descriptions may be automatically modified according to a network environment where a specific internet-of-things device is located, and may also be modified actively by a user according to the user's own demands. For example, the usage descriptions of the internet-of-things devices record which protocols are needed to transmit data, which ports are used, and which application servers the data packets need to be sent to or received from, etc. The above examples are only used for describing the present disclosure, and are not intended to specifically define the present disclosure.

In addition to generating the DSCP table using the manufacturer usage descriptions, the software-defined network controller 212 may also generate an access control list (ACL) 224. The access control list includes source addresses, destination addresses, used protocol identifications, etc.

As shown in FIG. 2, a programmable switch 210 may obtain the DSCP table and the ACL. Additionally, an updated ACL may also be sent to the programmable switch 210 by updating ACL rules. Then, the programmable switch may generate an ahead service forwarding table 226 and a back service forwarding table 228 according to information in the DSCP table and the ACL. The ahead service forwarding table 226 is used for filtering the data packets sent by the internet-of-things devices, and the back service forwarding table 228 is used for filtering received data packets to be sent to the internet-of-things devices.

FIG. 2 further shows a network 216. The network 216 is used for connecting an application server 218 and an application server 220 with the programmable switch 210 so as to interact with the programmable switch 210. The application server 218 and the application server 220 may send the data packets or services to the programmable switch 210 through the network 216 or receive the data packets or services from the programmable switch 210.

As shown in FIG. 2, the programmable switch 210 receives a data packet, such as a data packet from the customer premise equipment 206 or a data packet from an application server. Then the programmable switch 210 will perform a filtering operation on the data packet. When a DSCP identification corresponding to a to-be-protected target internet-of-things device does not exist in the data packet or service, the data packet or service is normally forwarded. When the DSCP identification corresponding to the to-be-protected target internet-of-things device exists in the data packet or service, it may be determined that the data packet or service is for the to-be-protected target internet-of-things device. At this time, a further filtering operation is needed. For example, after the programmable switch 210 receives a data packet from the customer premise equipment 206 or a data packet from the application server, it will detect a value of a DSCP in a DSCP field in a header of the data packet. For example, if the value of the DSCP of the data packet received from the customer premise equipment 206 is 2, the programmable switch 210 may find whether the DSCP exists from the DSCP table 222 to determine that the data packet is for the to-be-protected target internet-of-things device.

In an example, when the data packet is from the internet-of-things device or a destination is the application server, the programmable switch 210 matches information included in the header of the packet with information in the ahead service forwarding table 226. If they match, it indicates that the data packet is a data packet which meets security requirements, and then the data packet is forwarded to the corresponding application server. If they do not match, it indicates that the data packet does not meet the security requirements, and then the packet is abandoned. For example, if the data packet is a data packet which comes from the customer premise equipment 206 and is to be sent to the application server, when the DSCP is 2, as the service identification exists in the DSCP table 222, a protocol identification, a source IP address, a destination IP address, and a port are then obtained from the head of the data packet, and then these data are compared with forwarding information items in the ahead forwarding table. If the DSCP obtained from the data packet is 2, the protocol identification is 6, the source IP address is 10.11.11.1, the destination IP address is 10.22.22.2, and the port is 443, then at this time, a completely corresponding forwarding information item may be found from the ahead service forwarding table 226. Therefore, the data packet may be forwarded, and if the corresponding forwarding information item is not found, then the packet is abandoned.

In another example, when the data packet is from the application server or a destination is the internet-of-things device or a local network, the programmable switch 210 matches information included in the header of the packet with information in the back service forwarding table 228. If they match, it indicates that the data packet is a data packet which meets security requirements, and then the data packet is forwarded to the corresponding customer premise equipment. If they do not match, it indicates that the data packet does not meet the security requirements, and then the packet is abandoned.

Through the method, normal packets are forwarded and possible attack data packets are abandoned by filtering the data packets, and thus the internet-of-things device is prevented from being attacked, which improves the security of the internet-of-things device and improves the user experience. In addition, since the programmable switch and the manufacturer usage description server can be utilized, corresponding configuration information may be flexibly adjusted in customized and automatic manners, the processing efficiency is improved, the flexibility of security gateways of the internet-of-things is improved, and the memory overhead of a monitoring and detecting system is reduced.

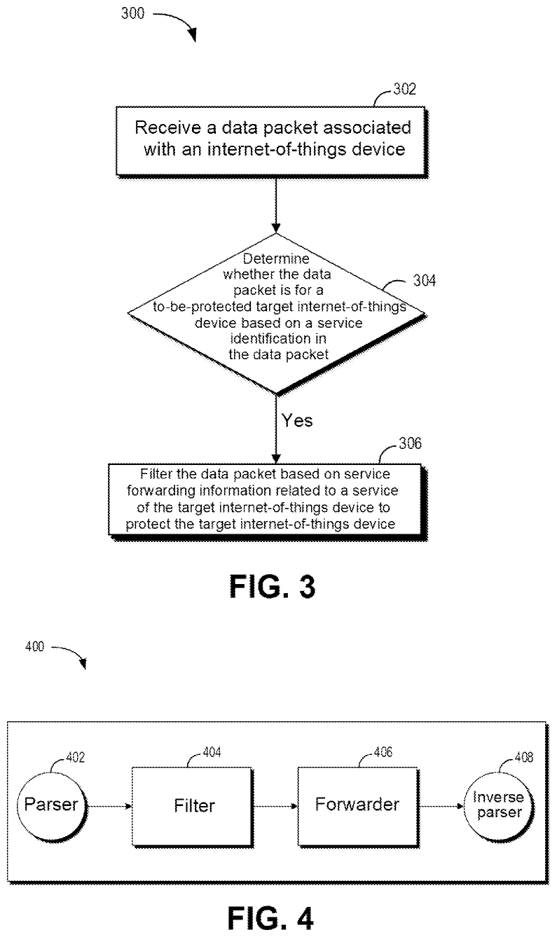

The schematic diagram of the example of enhancing network security of the internet-of-things device according to an embodiment of the present disclosure is described above in conjunction with FIG. 2. A flow chart of a method for enhancing network security of an internet-of-things device according to an embodiment of the present disclosure is described below in conjunction with FIG. 3. The method may be executed on, for example, the computing device 104 in FIG. 1, the programmable switch 210 in FIG. 2, or any suitable computing device or server.

In an example method 300 in FIG. 3, at block 302, a computing device receives a data packet associated with the internet-of-things device. For example, the computing device may receive a data packet from the internet-of-things device via customer premise equipment, and may also receive a data packet from an application server via a network. In some embodiments, the data packet includes a header, and the header may include a plurality of fields such as a service identification field, such as a DSCP field. Additionally, the header may further include a protocol type, a source address, a destination address, a port field, etc.

At block 304, the computing device determines whether the data packet is for a to-be-protected target internet-of-things device based on a service identification in the data packet. For example, the computing device may obtain a DSCP table and an ACL from the software-defined network controller 212 so as to obtain a DSCP of the to-be-protected target internet-of-things device.

In some embodiments, when a service identification corresponding to the target internet-of-things device exists in the data packet or service, the computing device may determine that the data packet or service is for the to-be-protected target internet-of-things device, and at this time, a further filtering operation is further needed. If the service identification corresponding to the target internet-of-things device does not exist in the data packet or service, it indicates that the data packet is associated with a normal internet-of-things device, and thus the computing device may forward the data packet or service normally.

If the data packet is for the to-be-protected target internet-of-things device, then at block 306, the computing device filters the data packet based on service forwarding information related to a service of the target internet-of-things device to protect the target internet-of-things device. For example, when it is determined through the service identification that the data packet is for the to-be-protected target internet-of-things device, the further filtering operation needs to be performed further according to the service forwarding information.

In some embodiments, in the further filtering operation, the computing device obtains the header of the received data packet, where the header includes the service identification and a destination to which the data packet is to be sent. Additionally, the header further includes a protocol, a source address, and a port number. Then, the computing device finds whether a forwarding information item corresponding to the header exists in the service forwarding information by using the service identification and the destination. If the forwarding information item corresponding to the header exists in the service forwarding information, it indicates that the data packet is a data packet meeting security requirements, and then the data packet is sent to the destination. If the forwarding information item corresponding to the header is not found in the service forwarding information, it indicates that the data packet is a data packet not meeting the security requirements, and then the data packet is abandoned.

In some embodiments, the data packet is received from the customer premise equipment, and the computing device 104 filters the data packet according to ahead service forwarding information. In some embodiments, the data packet is received from the application server, and the computing device filters the data packet according to back service forwarding information. Additionally, when the forwarding information item corresponding to the header in the data packet or service does not exist in the ahead service forwarding information and/or the back service forwarding information received by the computing device, the data packet or service is abandoned.

Through the method, normal packets are forwarded and possible attack data packets are abandoned by filtering the data packets, and thus the internet-of-things device is prevented from being attacked, which improves the security of the internet-of-things device and improves the user experience.

The flow chart of the method for enhancing network security of the internet-of-things device according to an embodiment of the present disclosure is described above in conjunction with FIG. 3. A flow of executing filtering on a data plane by a computing device is described below in conjunction with FIG. 4. FIG. 4 illustrates a schematic diagram of an example of the flow of executing filtering on the data plane according to an embodiment of the present disclosure.

As shown in FIG. 4, in an example 400, executing a filtering operation on the data plane by a programmable switch is realized by four components including a parser 402, a filter 404, a forwarder 406, and an inverse parser 408.

When receiving data packets or services, the parser 402 extracts headers from the data packets first, and checks contents in the header of each data packet, including a DSCP, a source IP address, a destination IP address, and/or a port. In an example, the length of a header changes with the change of the length of a request domain.

When the filter 404 executes a filtering operation on a data packet, it may be determined that the data packet or service is for a to-be-protected target internet-of-things device when a service identification corresponding to the target internet-of-things device exists in the data packet or service. When the service identification corresponding to the target internet-of-things device does not exist in the data packet or service, the data packet or service is normally forwarded.

The filter 404 will also execute further filtering on the data packet for the to-be-protected target internet-of-things device. At this time, the filter 404 performs matching on a protocol identification, a source address, a destination address, and a port in the head of the data packet with a forwarding information item formed by a row of data in a service forwarding table. For example, the filter 404 checks whether the forwarding information item corresponding to the header of the data packet or service exists in an ahead service forwarding table and/or a back service forwarding table. If the matched forwarding information item exists, the data packet or service needs to be forwarded to the destination, and if the matched forwarding information item does not exist, the data packet or service is abandoned. As for the data packet or service which needs to be forwarded to the destination, the forwarder 406 is used for forwarding the data packet to CPE or an application server.

The inverse parser 408 reconstructs the data packet to be sent. The inverse parser 408 corresponds to the parser 402 and may generate headers of all the parsed data packets.

Through the method, normal packets are forwarded and possible attack data packets are abandoned by filtering the data packets, and thus the internet-of-things device is prevented from being attacked, which improves the security of the internet-of-things device and improves the user experience.

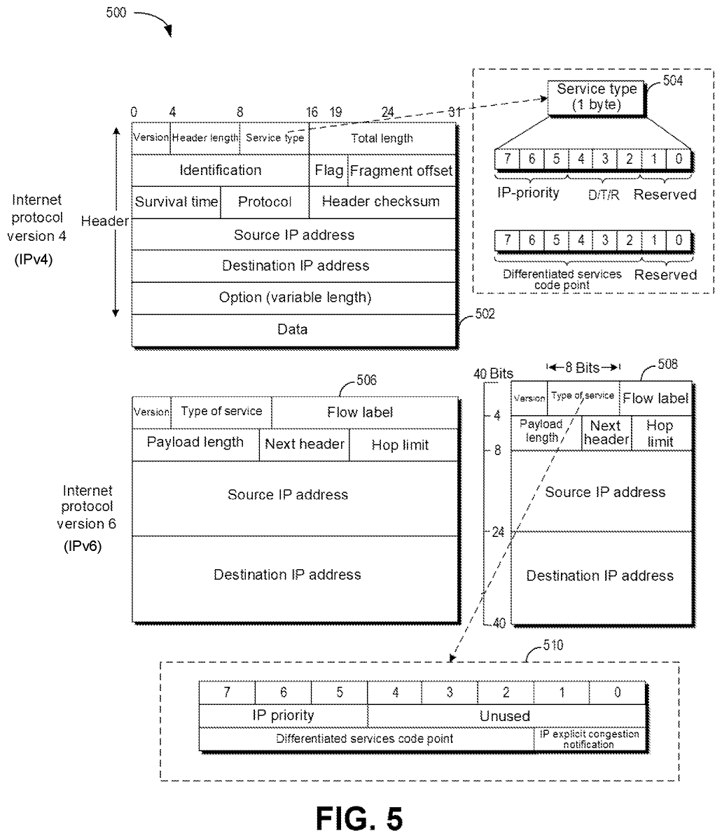

An example 500 of a header definition according to an embodiment of the present disclosure is described below in conjunction with FIG. 5. Differentiated services code points described in this example are a mechanism used for classifying data packets or services on an IP network.

FIG. 5 shows a header 502 of an Internet protocol version 4 (IPv4) and a header 506 of an Internet protocol version 6 (IPv6). In an example, a service type field 504 in information of the IPv4 header describes that it uses 6 bits in an IP header to represent a differentiated services code point so as to classify the data packets or services. A specific example 508 of the IPv6 header has a service category 510, which uses third-layer classification such that a user can maintain the same classification semantics across routers out of a local network. Therefore, DSCPs may be used to mark the data packets or services, and types of internet-of-things devices may be determined by using self-defined values.

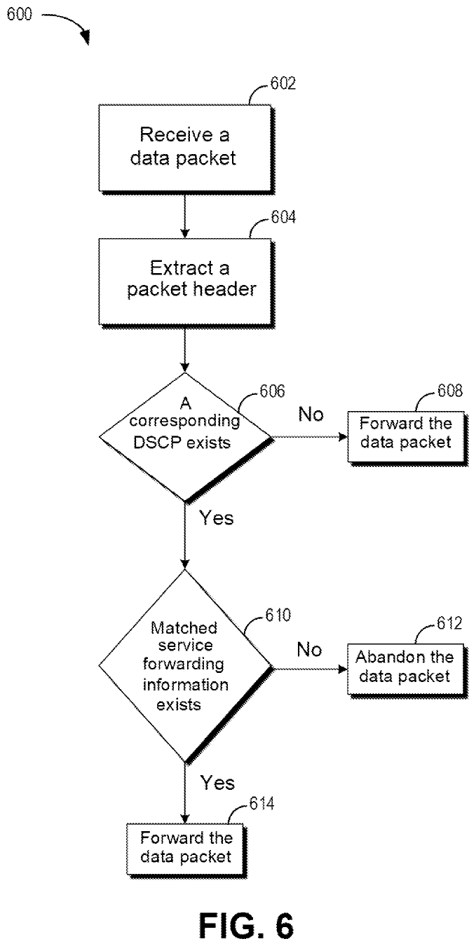

FIG. 6 shows a flow chart of an example 600 of enhancing an internet-of-things device according to an embodiment of the present disclosure. At block 602, a computing device receives a data packet associated with the internet-of-things device at a programmable switch. At block 604, the programmable switch extracts a packet header from a header of the data packet. A DSCP field exists in the header of the data packet, and the programmable switch may extract a DSCP from this field as a service identification.

Further, at block 606, whether the DSCP of the data packet or service received by the programmable switch exists in a DSCP of a to-be-protected internet-of-things device is determined. If the DSCP in the data packet or service does not exist in the DSCP of the to-be-protected internet-of-things device, then at block 608, the data packet is forwarded. If the DSCP in the data packet or service exists in the DSCP of the to-be-protected internet-of-things device, then the data packet is for the to-be-protected target internet-of-things device, and it enters block 610.

At block 610, the programmable switch determines whether matched service forwarding information exists. The programmable switch matches information in the header of the data packet with service forwarding information in a service forwarding table. For example, the information in the header of the data packet is matched with a forwarding item in an ahead service forwarding table and/or a back service forwarding table. If they match, the data packet is forwarded at block 614. If they do not match, the data packet is abandoned at block 612. Through the method, normal packets are forwarded and possible attack data packets are abandoned by filtering the data packets, and thus the internet-of-things device is prevented from being attacked, which improves the security of the internet-of-things device and improves the user experience.

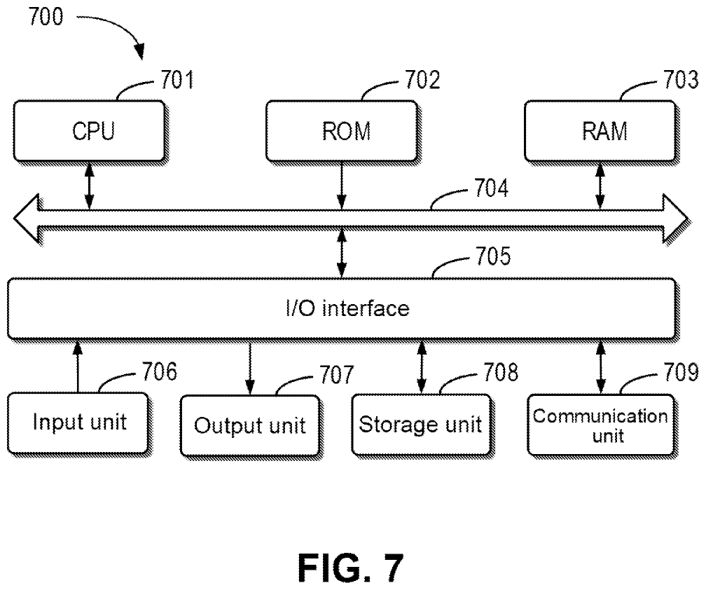

FIG. 7 illustrates a block diagram of an example device 700 which can be used to implement embodiments of the present disclosure. The computing device 104 in FIG. 1 and the programmable switch 210 in FIG. 2 may be implemented by the example device 700. As shown in the figure, the device 700 includes a central processing unit (CPU) 701 that may execute various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The CPU 701, the ROM 702, and the RAM 703 are connected to each other through a bus 704. An input/output (I/O) interface 705 is also connected to the bus 704.

Multiple components in the device 700 are connected to the I/O interface 705, including: an input unit 706, such as a keyboard and a mouse; an output unit 707, such as various types of displays and speakers; a storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The various processes and processing described above, such as the method 300, may be performed by the CPU 701. For example, in some embodiments, the method 300 may be implemented as a computer software program that is tangibly included in a machine-readable medium such as the storage unit 708. In some embodiments, part or all of the computer program may be loaded and/or installed onto the device 700 via the ROM 702 and/or the communication unit 709. When the computer program is loaded into the RAM 703 and executed by the CPU 701, one or more actions of the process or method 300 described above may be implemented.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an crasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, another programmable data processing apparatus, or another device, so that a series of operating steps can be performed on the computer, the other programmable data processing apparatus, or the other device to produce a computer-implemented process, such that the instructions executed on the computer, the other programmable data processing apparatus, or the other device can implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms used herein is intended to best explain the principles and practical applications of the various embodiments and their associated technical improvements, so as to enable persons of ordinary skill in the art to understand the various embodiments disclosed herein.

What is claimed is:

1. A method for protecting an internet-of-things device, comprising:
receiving a data packet associated with the internet-of-things device;
determining whether the data packet is for a to-be-protected target internet-of-things device based on a service identification in the data packet; and
filtering, in response to the data packet being for the to-be-protected target internet-of-things device, the data packet based on service forwarding information related to a service of the target internet-of-things device to protect the target internet-of-things device.

2. The method according to claim 1, wherein determining whether the data packet is for the to-be-protected target internet-of-things device comprises:
determining whether the service identification corresponding to the target internet-of-things device exists in the data packet; and
determining that the data packet is for the to-be-protected target internet-of-things device in response to the service identification corresponding to the target internet-of-things device existing in the data packet.

3. The method according to claim 2, wherein determining whether the data packet is for the to-be-protected target internet-of-things device further comprises:
forwarding the data packet in response to the service identification corresponding to the target internet-of-things device not existing in the data packet.

4. The method according to claim 1, wherein filtering the data packet comprises:
determining a header of the data packet, the header comprising the service identification and a destination to which the data packet is to be sent;
determining whether a forwarding information item corresponding to the header exists in the service forwarding information based on the service identification and the destination; and
sending the data packet to the destination in response to the forwarding information item corresponding to the header existing in the service forwarding information.

5. The method according to claim 4, wherein filtering the data packet further comprises:
abandoning the data packet in response to the forwarding information item corresponding to the header not existing in the service forwarding information.

6. The method according to claim 4, wherein the service forwarding information comprises:
ahead service forwarding information and/or back service forwarding information.

7. The method according to claim 6, wherein determining whether the forwarding information item corresponding to the header exists in the service forwarding information comprises:
determining whether the forwarding information item corresponding to the header exists in the ahead service forwarding information in response to the destination being an external server; and
determining whether the forwarding information item corresponding to the header exists in the back service forwarding information in response to the destination being a local network device.

8. The method according to claim 1, further comprising:
receiving network information related to the internet-of-things device, the network information comprising at least one of the following: differentiated services code point information and access control information associated with the internet-of-things device; and
generating the service forwarding information based on the network information.

9. The method according to claim 8, wherein the differentiated services code point information and the access control information are generated based on a usage description of the internet-of-things device.

10. The method according to claim 8, further comprising:
updating the service forwarding information in response to the access control information being updated.

11. An electronic device, comprising:
at least one processor; and
a memory, coupled to the at least one processor and having instructions stored therein, wherein the instructions, when executed by the at least one processor, cause the electronic device to perform actions comprising:
receiving a data packet associated with an internet-of-things device;
determining whether the data packet is for a to-be-protected target internet-of-things device based on a service identification in the data packet; and
filtering, in response to the data packet being for the to-be-protected target internet-of-things device, the data packet based on service forwarding information related to a service of the target internet-of-things device.

12. The electronic device according to claim 11, wherein determining whether the data packet is for the to-be-protected target internet-of-things device comprises:
determining whether the service identification corresponding to the target internet-of-things device exists in the data packet; and
determining that the data packet is for the to-be-protected target internet-of-things device in response to the service identification corresponding to the target internet-of-things device existing in the data packet.

13. The electronic device according to claim 12, wherein determining whether the data packet is for the to-be-protected target internet-of-things device further comprises:
forwarding the data packet in response to the service identification corresponding to the target internet-of-things device not existing in the data packet.

14. The electronic device according to claim 11, wherein filtering the data packet comprises:
determining a header of the data packet, the header comprising the service identification and a destination to which the data packet is to be sent;
determining whether a forwarding information item corresponding to the header exists in the service forwarding information based on the service identification and the destination; and
sending the data packet to the destination in response to the forwarding information item corresponding to the header existing in the service forwarding information.

15. The electronic device according to claim 14, wherein filtering the data packet further comprises:
abandoning the data packet in response to the forwarding information item corresponding to the header not existing in the service forwarding information.

16. The electronic device according to claim 14, wherein the service forwarding information comprises:
ahead service forwarding information and/or back service forwarding information.

17. The electronic device according to claim 16, wherein determining whether the forwarding information item corresponding to the header exists in the service forwarding information comprises:
determining whether the forwarding information item corresponding to the header exists in the ahead service forwarding information in response to the destination being an external server; and
determining whether the forwarding information item corresponding to the header exists in the back service forwarding information in response to the destination being a local network device.

18. The electronic device according to claim 11, wherein the actions further comprise:
receiving network information related to the internet-of-things device, the network information comprising at least one of the following: differentiated services code point information and access control information associated with the internet-of-things device; and
generating the service forwarding information based on the network information.

19. The electronic device according to claim 18, wherein the differentiated services code point information and the access control information are generated based on a usage description of the internet-of-things device; and the actions further comprise:
updating the service forwarding information in response to the access control information being updated.

20. A computer program product, the computer program product being tangibly stored on a non-transitory computer-readable medium and comprising machine-executable instructions, wherein the machine-executable instructions, when executed by a machine, cause the machine to perform:
receiving a data packet associated with an internet-of-things device;
determining whether the data packet is for a to-be-protected target internet-of-things device based on a service identification in the data packet; and
filtering, in response to the data packet being for the to-be-protected target internet-of-things device, the data packet based on service forwarding information related to a service of the target internet-of-things device.
